(19) United States
(12) Patent Application Publication
(10) Pub. No.: US 2024/0067232 A1
(43) Pub. Date: Feb. 29, 2024

(54) VEHICLE CONTROLLER, VEHICLE CONTROL METHOD, AND VEHICLE CONTROL COMPUTER PROGRAM FOR VEHICLE CONTROL

(71) Applicant: TOYOTA JIDOSHA KABUSHIKI KAISHA, Toyota-shi, Aichi-ken (JP)

(72) Inventor: Ryusuke Kuroda, Edogawa-ku, Tokyo-to (JP)

(21) Appl. No.: 18/448,387

(22) Filed: Aug. 11, 2023

(30) Foreign Application Priority Data
Aug. 25, 2022 (JP) 2022-134066

(51) Int. Cl. B60W 60/00; B60W 40/04

(52) U.S. Cl. CPC B60W 60/0053; B60W 40/04; B60W 2555/00

(57) ABSTRACT

The vehicle controller includes a processor configured to determine a rear detection range within which an object is detectable behind a vehicle, based on a sensor signal from a sensor mounted on the vehicle, the sensor being capable of detecting objects around the vehicle, and change the level of autonomous driving control applied to the vehicle to increase the degree of a driver's involvement in driving, when the rear detection range has been less than a first distance threshold for more than a first predetermined time.

### FIELD

The present invention relates to a vehicle controller, a vehicle control method, and a vehicle control computer program for autonomous driving control of a vehicle.

### BACKGROUND

In autonomous driving control of a vehicle, it is desirable that objects around the vehicle can be accurately detected to ensure safety of the vehicle. In view of this, a technique to control a vehicle according to the detection range of a sensor mounted on the vehicle has been proposed (see Japanese Unexamined Patent Publication No. 2020-125103).

A method for autonomously operating a vehicle described in JP2020-125103A includes assigning the position of the vehicle to a location in an topographic map containing slope information; retrieving slope information from the topographic map for a predetermined range in front of and behind the location of the vehicle; and determining a maximum detection distance of front and rear sensors for detecting an object having a specific vertical height, based on the slope information, the positions of the front and rear sensors, and a vertical opening angle of a field of view of the front sensor. The method further includes determining a minimum detection distance of the front and rear sensors required for a planned driving maneuver or a current driving state of the vehicle; and actuating the vehicle such that the required minimum detection distance is equal or smaller than the maximum detection distance of the front and rear sensors.

### SUMMARY

Even under autonomous driving control, vehicles have to obey laws and regulations related to travel of vehicles. In particular, when an emergency vehicle is traveling near a vehicle under autonomous driving control, the vehicle should be controlled so as not to prevent travel of the emergency vehicle. However, a vehicle under autonomous driving control may be followed by another vehicle. In such a case, the view around the vehicle under autonomous driving control, in particular, behind the vehicle may be obstructed, which may prevent the vehicle from monitoring the surroundings of the vehicle sufficiently.

It is an object of the present invention to provide a vehicle controller that can reduce the possibility of a collision of a host vehicle with an object approaching from behind the host vehicle even if it is difficult to detect the approaching object.

According to an embodiment, a vehicle controller that executes autonomous driving control of a vehicle is provided. The vehicle controller includes a processor configured to: determine a rear detection range within which an object is detectable behind the vehicle, based on a sensor signal from a sensor mounted on the vehicle, the sensor being capable of detecting objects around the vehicle, and change the level of autonomous driving control applied to the vehicle to increase the degree of a driver's involvement in driving, when the rear detection range has been less than a first distance threshold for more than a first predetermined time.

The processor of the vehicle controller is preferably further configured to determine whether traffic around the vehicle is congested. In the case where traffic around the vehicle is congested, the processor preferably changes the level of autonomous driving control applied to the vehicle from a control level at which the driver's involvement is unnecessary to a control level at which the driver's involvement is necessary, when the rear detection range has been less than the first distance threshold for more than the first predetermined time.

When the rear detection range has been less than a second distance threshold greater than the first distance threshold for more than a second predetermined time, the processor of the vehicle controller preferably makes the amount of adjustment to the position of the vehicle in a lane being traveled by the vehicle in a direction traversing the lane less than when the rear detection range is not less than the second distance threshold.

The processor of the vehicle controller preferably sets the first distance threshold for the case where a road being traveled by the vehicle has a road shoulder less than the first distance threshold for the case where the road being traveled by the vehicle does not have a road shoulder.

The processor of the vehicle controller is preferably further configured to detect an object in an area around the vehicle, based on the sensor signal. The processor preferably determines whether a road shoulder of a road being traveled by the vehicle is passable by another vehicle in a most recent predetermined period, based on the result of detection of the object, and sets the first distance threshold for the case where the road shoulder is passable by another vehicle less than the first distance threshold for the case where the road shoulder is impassable to another vehicle.

Alternatively, the processor of the vehicle controller preferably sets the first distance threshold smaller as a road being traveled by the vehicle has a narrower lane.

According to another embodiment, a vehicle control method for autonomous driving control of a vehicle is provided. The method includes determining a rear detection range within which an object is detectable behind the vehicle, based on a sensor signal from a sensor mounted on the vehicle, the sensor being capable of detecting objects around the vehicle; and changing the level of autonomous driving control applied to the vehicle to increase the degree of a driver's involvement in driving, when the rear detection range has been less than a first distance threshold for more than a first predetermined time.

According to still another embodiment, a non-transitory recording medium that stores a vehicle control computer program for autonomous driving control of a vehicle is provided. The computer program includes instructions causing a processor mounted on a vehicle to execute a process including determining a rear detection range within which an object is detectable behind the vehicle, based on a sensor signal from a sensor mounted on the vehicle, the sensor being capable of detecting objects around the vehicle; and changing the level of autonomous driving control applied to the vehicle to increase the degree of a driver's involvement in driving, when the rear detection range has been less than a first distance threshold for more than a first predetermined time.

The vehicle controller according to the present disclosure has an advantageous effect of being able to reduce the possibility of a collision of a host vehicle with an object approaching from behind the host vehicle even if it is difficult to detect the approaching object.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process.

FIG. 4A illustrates a rear detection range.

FIG. 4B illustrates a rear detection range.

FIG. 5 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller determines a distance within which an object is detectable behind a host vehicle (hereafter a “rear detection range”), based on a sensor signal obtained by a sensor mounted on the host vehicle. The sensor is capable of detecting objects around the host vehicle. The vehicle controller changes the level of autonomous driving control applied to the vehicle to increase the degree of a driver's involvement in driving, when the rear detection range has been less than a first distance threshold for more than a first predetermined time.

In the present embodiment, the vehicle controller can apply level 2 autonomous driving control defined by the Society of Automotive Engineers (SAE) to the host vehicle. More specifically, the vehicle controller can execute autonomous driving control of the host vehicle on condition that the driver is looking around the host vehicle. The vehicle controller may further be able to apply level 3 autonomous driving control to the host vehicle under a particular condition, e.g., when traffic around the host vehicle is congested. More specifically, when traffic around the host vehicle is congested, the vehicle controller may be able to execute autonomous driving control of the host vehicle even if the driver is not looking around.

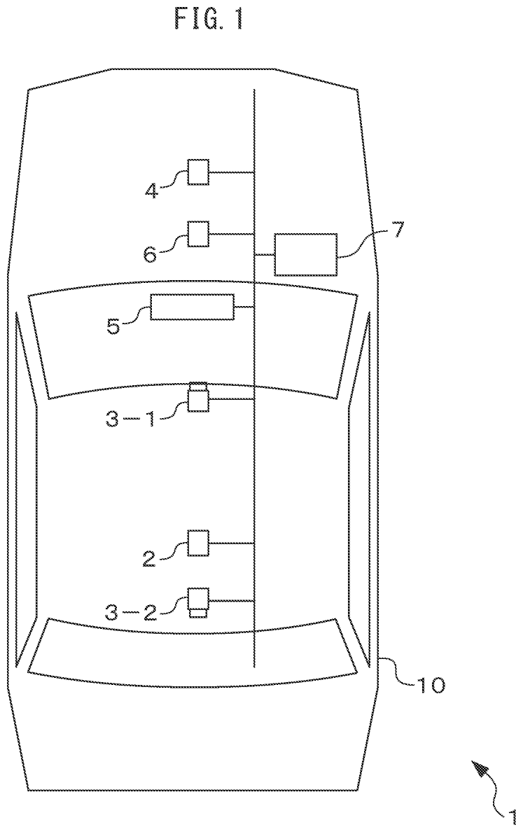

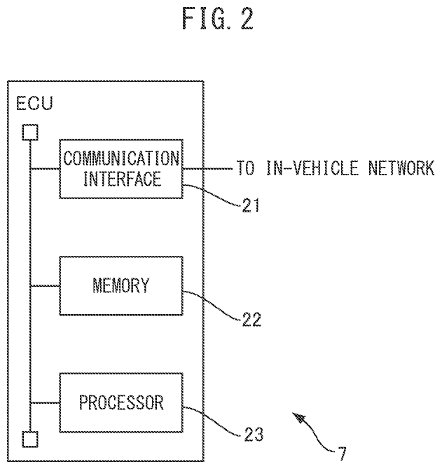

FIG. 1 schematically illustrates the configuration of a vehicle control system equipped with the vehicle controller. FIG. 2 illustrates the hardware configuration of an electronic control unit, which is an embodiment of the vehicle controller. The vehicle control system 1, which is mounted on a vehicle 10 and controls the vehicle 10, includes a GPS receiver 2, two cameras 3-1 and 3-2, a wireless communication terminal 4, a user interface 5, a storage device 6, and an electronic control unit (ECU) 7, which is an example of the vehicle controller. The GPS receiver 2, the cameras 3-1 and 3-2, the wireless communication terminal 4, the user interface 5, and the storage device 6 are communicably connected to the ECU 7 via an in-vehicle network conforming to a standard such as a controller area network. The vehicle 10 is an example of the host vehicle. The vehicle control system 1 may further include a range sensor (not illustrated) that measures the distances from the vehicle 10 to objects around the vehicle 10, such as LiDAR or radar. Such a range sensor is an example of the sensor capable of detecting objects around the vehicle 10. The vehicle control system 1 may further include a navigation device (not illustrated) for searching for a planned travel route to a destination.

The GPS receiver 2 receives GPS signals from GPS satellites at predetermined intervals, and determines the position of the vehicle 10, based on the received GPS signals. The GPS receiver 2 outputs positioning information indicating the result of determination of the position of the vehicle 10 based on the GPS signals to the ECU 7 via the in-vehicle network at predetermined intervals. Instead of the GPS receiver 2, the vehicle 10 may include a receiver conforming to another satellite positioning system. In this case, this receiver determines the position of the vehicle 10.

The cameras 3-1 and 3-2 are examples of the sensor capable of detecting objects around the vehicle 10. The cameras 3-1 and 3-2 each includes a two-dimensional detector constructed from an array of optoelectronic transducers, such as CCD or C-MOS, having sensitivity to visible light and a focusing optical system that forms an image of a target region on the two-dimensional detector. The camera 3-1 is mounted, for example, in the interior of the vehicle 10 so as to be oriented to the front of the vehicle 10. The camera 3-2 is mounted, for example, in the interior of the vehicle 10 so as to be oriented to the rear of the vehicle 10. The cameras 3-1 and 3-2 take pictures of regions in front of and behind the vehicle 10, respectively, every predetermined capturing period (e.g., 1/30 to 1/10 seconds), and generate images representing these regions. Each image obtained by the cameras 3-1 and 3-2 is an example of the sensor signal, and may be a color or grayscale image. The vehicle 10 may include three or more cameras taking pictures in different orientations or having different focal lengths. For example, the vehicle 10 may include a camera oriented to the side of the vehicle 10, besides the cameras 3-1 and 3-2.

Every time an image is generated, the cameras 3-1 and 3-2 each output the generated image to the ECU 7 via the in-vehicle network.

The wireless communication terminal 4 communicates with a wireless base station by wireless in conformity with a predetermined standard of mobile communications. The wireless communication terminal 4 receives traffic information indicating the traffic situation of a road being traveled by the vehicle 10 or an area therearound, e.g., information provided by the Vehicle Information and Communication System (VICS [registered trademark]) from another device via the wireless base station. The wireless communication terminal 4 outputs the received traffic information to the ECU 7 via the in-vehicle network. The traffic information includes, for example, information on sections where traffic is congested, the presence or absence of road construction, an accident, or traffic restrictions, and the places and times of day at which road construction is carried out, an accident occurred, or traffic restrictions are imposed. The wireless communication terminal 4 may receive a high-precision map of a predetermined region around the current position of the vehicle 10, which is used for autonomous driving control, from a map server via the wireless base station, and output the received high-precision map to the storage device 6.

The user interface 5, which is an example of a notification unit, includes, for example, a display, such as a liquid crystal display, or a touch screen display. The user interface 5 is mounted in the interior of the vehicle 10, e.g., near an instrument panel, so as to face the driver. The user interface 5 displays various types of information received from the ECU 7 via the in-vehicle network, in the form of an icon or text, to notify the driver of this information. The user interface 5 may further include a speaker mounted in the vehicle interior or a vibrator provided in the steering or the driver's seat. In this case, the user interface 5 outputs various types of information received from the ECU 7 via the in-vehicle network, in the form of a voice signal, to notify the driver of this information. Alternatively, the user interface 5 may vibrate the vibrator according to a signal received from the ECU 7 via the in-vehicle network to call the driver's attention to predetermined matters with this vibration.

The storage device 6, which is an example of a storage unit, includes, for example, a hard disk drive, a nonvolatile semiconductor memory, or an optical medium and an access device therefor. The storage device 6 stores a high-precision map, which is an example of map information. The high-precision map includes, for example, information indicating road markings, such as lane-dividing lines or stop lines, and traffic signs on individual roads within a predetermined region represented in the high-precision map as well as information indicating features around the roads (e.g., noise-blocking walls).

The storage device 6 may further include a processor for executing, for example, a process to update a high-precision map and a process related to a request from the ECU 7 to read out a high-precision map. In this case, for example, every time the vehicle 10 moves a predetermined distance, the storage device 6 transmits a request to obtain a high-precision map, together with the current position of the vehicle 10, to the map server via the wireless communication terminal 4, and receives a high-precision map of a predetermined region around the current position of the vehicle 10 from the map server via the wireless communication terminal 4. Upon receiving a request from the ECU 7 to read out a high-precision map, the storage device 6 cuts out that portion of a high-precision map stored therein which includes the current position of the vehicle 10 and which represents a region smaller than the predetermined region, and outputs the cutout portion to the ECU 7 via the in-vehicle network.

The ECU 7 detects other vehicles traveling around the vehicle 10, and controls travel of the vehicle 10, based on the detected vehicles.

As illustrated in FIG. 2, the ECU 7 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 7 to the in-vehicle network. Every time positioning information is received from the GPS receiver 2, the communication interface 21 passes the positioning information to the processor 23. Every time an image is received from the camera 3-1 or 3-2, the communication interface 21 passes the received image to the processor 23. Further, the communication interface 21 passes a high-precision map read from the storage device 6 to the processor 23. Further, the communication interface 21 outputs information or a signal addressed to the user interface 5 received from the processor 23 to the user interface 5 via the in-vehicle network.

The memory 22, which is another example of a storage unit, includes, for example, volatile and nonvolatile semiconductor memories, and stores various types of data used in a vehicle control process executed by the processor 23 of the ECU 7. For example, the memory 22 stores a high-precision map; parameters indicating the focal lengths, the angles of view, the orientations, and the mounted positions of the cameras 3-1 and 3-2; and a set of parameters for specifying a classifier for object detection used for detecting traveling vehicles around the vehicle 10. In addition, the memory 22 temporarily stores sensor signals, such as images of the surroundings of the vehicle 10 generated by the camera 3-1 or 3-2; the result of determination of the position of the host vehicle by the GPS receiver 2; and various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10.

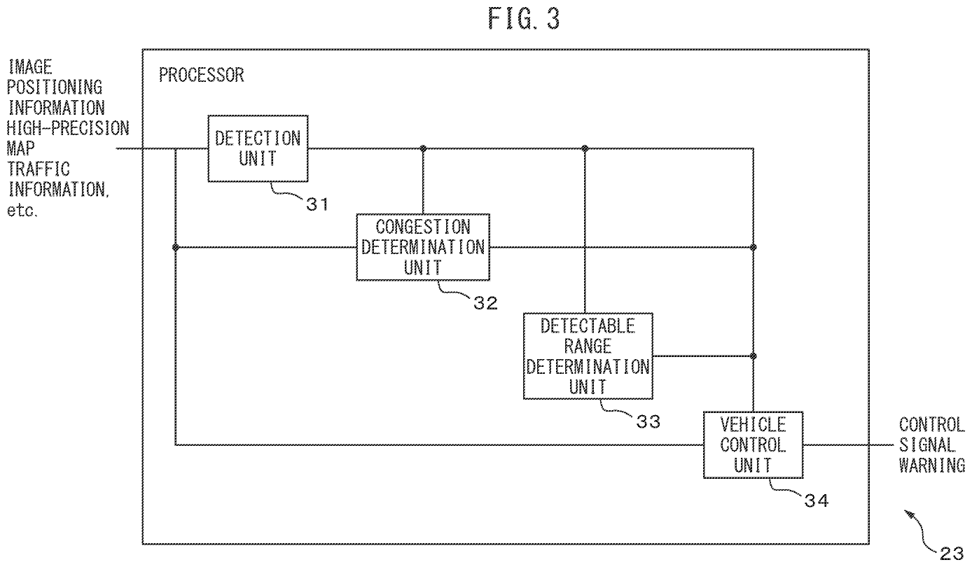

FIG. 3 is a functional block diagram of the processor 23, related to the vehicle control process. The processor 23 includes a detection unit 31, a congestion determination unit 32, a detectable range determination unit 33, and a vehicle control unit 34. These units included in the processor 23 are functional modules, for example, implemented by a computer program executed by the processor 23, or may be dedicated operating circuits provided in the processor 23.

Every time the ECU 7 obtains an image from the camera 3-1 or 3-2, the detection unit 31 detects vehicles around the vehicle 10, based on the obtained image.

For example, every time the ECU 7 obtains an image from the camera 3-1 or 3-2, the detection unit 31 inputs the image into a classifier to detect other vehicles traveling around the vehicle 10. As such a classifier, the detection unit 31 can use a deep neural network (DNN) having architecture of a convolutional neural network (CNN) type, such as Single Shot MultiBox Detector (SSD) or Faster R-CNN. Such a classifier is trained in advance to detect objects to be detected around the vehicle 10 (e.g., ordinary passenger cars, large-size vehicles, motorcycles, pedestrians, road markings such as lane-dividing lines, and signposts) from an image. The classifier outputs information for identifying object regions including objects detected in an inputted image and information indicating the types of the detected objects (e.g., ordinary passenger cars, large-size vehicles, motorcycles, pedestrians, road markings, and traffic signs). In the present embodiment, since the camera 3-2 is provided to take pictures of a region behind the vehicle 10, another vehicle represented in an image obtained from the camera 3-2 (hereafter a “rear image”) is a vehicle traveling behind the vehicle 10. Thus the detection unit 31 determines a vehicle detected by inputting a rear image into the classifier, as a vehicle behind.

Further, the detection unit 31 detects lane-dividing lines and a lane being traveled by the vehicle 10 (hereafter a “host vehicle lane”). In the present embodiment, lane-dividing lines as well as vehicles are detected by inputting an image obtained from the camera 3-1 or 3-2 into the classifier. Since the camera 3-2 is oriented to the rear of the vehicle 10, the detection unit 31 can determine a lane corresponding to a region sandwiched between two lane-dividing lines closest to the horizontal center of a rear image on the respective sides with respect to the horizontal center, as the host vehicle lane. The detection unit 31 can further determine the two lane-dividing lines as those demarcating the host vehicle lane.

For each detected vehicle behind, the detection unit 31 further identifies a lane being traveled by the vehicle behind. For example, the detection unit 31 compares the position of the detected vehicle behind in the rear image with the positions of individual lane-dividing lines detected from the rear image to identify the lane being traveled by the vehicle behind. More specifically, the detection unit 31 determines a lane corresponding to a region in the rear image sandwiched between two lane-dividing lines on the respective sides of the bottom of the object region representing the vehicle behind, as the lane being traveled by the vehicle behind. As described above, the detection unit 31 can determine a lane corresponding to a region sandwiched between two lane-dividing lines closest to the horizontal center of a rear image on the respective sides with respect to the horizontal center, as the host vehicle lane. Thus the detection unit 31 can identify the position of the lane being traveled by the vehicle behind relative to the host vehicle lane, by counting the number of lane-dividing lines between the region corresponding to the lane being traveled by the vehicle behind and the region corresponding to the host vehicle lane in the rear image.

In the case where the vehicle 10 is equipped with a range sensor, the detection unit 31 can estimate the direction from the vehicle 10 corresponding to the centroid of an object region representing a vehicle behind in a rear image, as the direction from the vehicle 10 to the vehicle behind. Further, the detection unit 31 can estimate the distance measured by the range sensor in this direction, as the distance from the vehicle 10 to the vehicle behind. From the estimated distance and direction to the vehicle behind, the detection unit 31 determines the distance from the vehicle 10 to the vehicle behind in a direction perpendicular to the travel direction of the vehicle 10 (a distance in a direction perpendicular to the travel direction of the vehicle 10 will be referred to as a “lateral distance” below). The detection unit 31 can identify the position of the lane being traveled by the vehicle behind relative to the host vehicle lane, by dividing the lateral distance by the lane width. The detection unit 31 refers to map information to identify the lane width at the position of the host vehicle measured by the GPS receiver 2.

The detection unit 31 notifies the congestion determination unit 32, the detectable range determination unit 33, and the vehicle control unit 34 of information indicating the detected vehicles behind and the positions of the lanes being traveled by the detected vehicles behind.

The congestion determination unit 32 determines whether traffic around the vehicle 10 is congested.

For example, the congestion determination unit 32 determines whether traffic around the vehicle 10 is congested, based on the positional relationship between the vehicle 10 and another vehicle traveling in an area around the vehicle 10 detected by the detection unit 31 or a relative speed of these vehicles.

To achieve this, the congestion determination unit 32 executes a predetermined tracking process, such as a tracking process using optical flow, on other vehicles detected from each of time-series images obtained from the camera 3-1 or 3-2 to track these vehicles. The congestion determination unit 32 executes viewpoint transformation on each image, using parameters of the camera 3-1 or 3-2, such as the focal length, the orientation, and the height of the mounted position, to transform the image into an aerial image. In this way, the congestion determination unit 32 calculates the positions of the tracked vehicles relative to the vehicle 10 at the time of acquisition of each image. To this end, the congestion determination unit 32 may use the distance to the tracked vehicle measured by the range sensor to calculate the relative position of the tracked vehicle, as described in relation to the detection unit 31. The bottom of an object region representing the tracked vehicle is assumed to correspond to the position where the tracked vehicle touches the road surface. Thus the congestion determination unit 32 may estimate the distance from the vehicle 10 to the tracked vehicle at the time of acquisition of each image, based on the direction from the camera 3-1 or 3-2 corresponding to the bottom of the object region representing the tracked vehicle in each image and the height of the mounted position. The congestion determination unit 32 may use the estimated distance to calculate the position of the tracked vehicle relative to the vehicle 10.

The congestion determination unit 32 selects a vehicle traveling ahead of the vehicle 10 among the vehicles being tracked. When there are multiple vehicles ahead, the congestion determination unit 32 may select the vehicle closest to the vehicle 10 of the vehicles ahead. The congestion determination unit 32 then calculates changes in the speed of the selected vehicle ahead relative to the vehicle 10 and changes in the distance between the selected vehicle ahead and the vehicle 10 in the most recent predetermined period (e.g., 3 to 5 seconds), based on changes in the relative position of the vehicle ahead in the most recent predetermined period.

The congestion determination unit 32 determines that traffic around the vehicle 10 is congested, when the absolute value of the speed of the vehicle ahead relative to the vehicle 10 has not been greater than a predetermined relative-speed threshold and the distance between the vehicle 10 and the vehicle ahead has been within a predetermined distance range for the most recent predetermined period. The relative-speed threshold is set, for example, at 1 m/s. The predetermined distance range is set, for example, between 3 m and 25 m. The most recent predetermined period is set, for example, between 3 and 5 seconds.

Alternatively, for every tracked vehicle, the congestion determination unit 32 may calculate changes in the speed of the tracked vehicle relative to the vehicle 10 and changes in the distance between the tracked vehicle and the vehicle 10 in the most recent predetermined period. The congestion determination unit 32 may determine that traffic around the vehicle 10 is congested, when the speed of every tracked vehicle relative to the vehicle 10 has not been greater than a predetermined relative-speed threshold (e.g., 3 m/s) for the most recent predetermined period.

Alternatively, the congestion determination unit 32 may determine whether traffic around the vehicle 10 is congested, based on time-varying changes in the speed of the vehicle 10 in the most recent predetermined period. For example, the congestion determination unit 32 determines that traffic around the vehicle 10 is congested, when the speed of the vehicle 10 has not been greater than a first speed threshold (e.g., 20 km/h) for more than a first period (e.g., 5 seconds). Alternatively, the congestion determination unit 32 may determine that traffic around the vehicle 10 is congested, when changes in the speed of the vehicle 10 have been within a predetermined speed range (e.g., 1 m/s) for a second period (e.g., 3 seconds).

Alternatively, the congestion determination unit 32 may determine that traffic around the vehicle 10 is congested, when the current position of the vehicle 10 measured by the GPS receiver 2 is within a congested section indicated by traffic information received via the wireless communication terminal 4. In this case, the congestion determination unit 32 identifies the road being traveled by the vehicle 10, by referring to the current position of the vehicle 10 and a high-precision map.

Alternatively, the congestion determination unit 32 may determine that traffic around the vehicle 10 is congested, only when it is determined so by two or more of the above-described techniques for determination of congestion.

The congestion determination unit 32 notifies the vehicle control unit 34 of the result of determination whether traffic around the vehicle 10 is congested.

The detectable range determination unit 33 determines a rear detection range within which an object is detectable behind the vehicle 10, at predetermined intervals (e.g., every capturing period of the camera 3-2 or at intervals of several dozen to several hundred milliseconds). When there is not an object obstructing view from the camera 3-2, the rear detection range is the maximum detectable range of the camera 3-2. When there is a vehicle behind following the vehicle 10 on a host vehicle lane being traveled by the vehicle 10, the vehicle behind obstructs view from the camera 3-2. Thus the rear detection range is the distance from the vehicle 10 to the vehicle behind.

Accordingly, when there is a vehicle traveling just behind the vehicle 10 on the host vehicle lane, the detectable range determination unit 33 determines the distance from the vehicle 10 to the vehicle behind as the rear detection range. The detectable range determination unit 33 can estimate the distance from the vehicle 10 to the vehicle traveling just behind the vehicle 10 on the host vehicle lane in the same manner as described in relation to the detection unit 31 or the congestion determination unit 32. Thus the detectable range determination unit 33 determines the distance estimated in accordance with this technique as the rear detection range.

When no vehicle traveling behind on the host vehicle lane is detected from a rear image generated by the camera 3-2, the view behind the vehicle 10 is not assumed to be obstructed. Thus the detectable range determination unit 33 determines the maximum detection range within which a vehicle behind represented in a rear image is detectable, as the rear detection range. The maximum detection range may be prestored in the memory 22, and is set to a value greater than first and second distance thresholds described below.

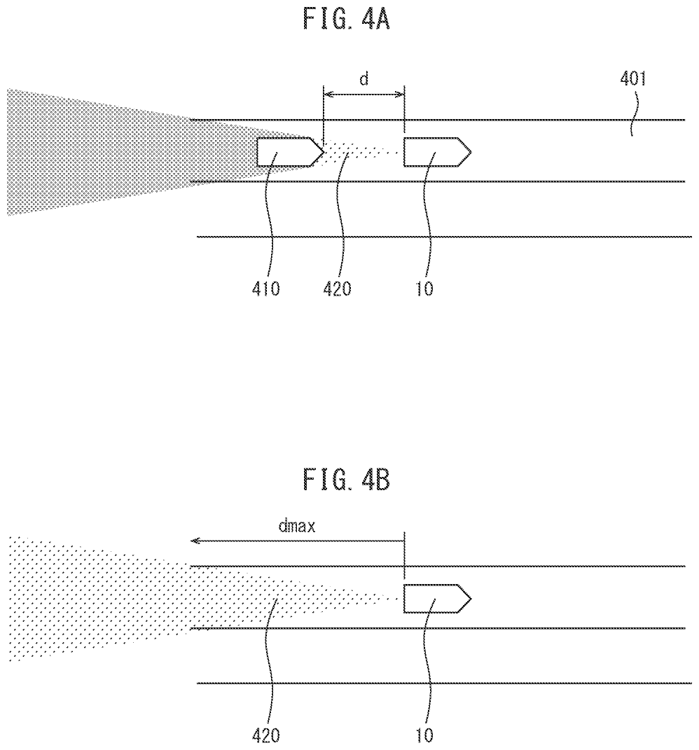

FIGS. 4A and 4B illustrate the rear detection range of the vehicle 10. In the example illustrated in FIG. 4A, a vehicle 410 is traveling behind the vehicle 10 on a lane 401 being traveled by the vehicle 10. Thus the view 420 behind the vehicle 10 is obstructed by the vehicle behind 410, and the distance d from the vehicle 10 to the vehicle behind 410 is the rear detection range.

In the example illustrated in FIG. 4B, there is not a vehicle traveling behind the vehicle 10 or an object obstructing the view 420 behind the vehicle 10. Thus the maximum detection range dmax is the rear detection range.

In the case where the vehicle 10 is equipped with a range sensor whose measurement range includes an area behind the vehicle 10, the detectable range determination unit 33 may determine the rear detection range, based on the result of measurement by the range sensor. For example, the detectable range determination unit 33 may determine the distance to an object within a measurement range measured by the range sensor as the rear detection range; the measurement range corresponds to the host vehicle lane and is above a predetermined height (e.g., 30 cm to 50 cm) from the road surface.

Every time the rear detection range is determined, the detectable range determination unit 33 notifies the vehicle control unit 34 of the rear detection range.

The vehicle control unit 34 changes the level of autonomous driving control applied to the vehicle 10, based on the rear detection range.

In the present embodiment, when it is determined by the congestion determination unit 32 that traffic around the vehicle 10 is congested, the vehicle control unit 34 determines whether the rear detection range has been less than a first distance threshold for more than a first predetermined time. When the rear detection range has been less than the threshold for more than a first predetermined time, the vehicle control unit 34 changes the level of autonomous driving control applied to the vehicle 10 to increase the degree of the driver's involvement in driving. The first distance threshold is set, for example, between 20 m and 30 m. The first predetermined time is set, for example, from several seconds to a dozen or so seconds.

When the level of autonomous driving control applied to the vehicle 10 does not require the driver's involvement in driving, the vehicle control unit 34 reduces the level of applied autonomous driving control to a control level at which the driver's involvement is necessary. For example, when level 3 autonomous driving control is applied to the vehicle 10, the vehicle control unit 34 changes autonomous driving control applied to the vehicle 10 to level 2 autonomous driving control. Alternatively, the vehicle control unit 34 may transfer control of the vehicle 10 to the driver of the vehicle 10. The vehicle control unit 34 notifies the driver of a warning depending on the reduced level of autonomous driving control via the user interface 5. For example, when changing autonomous driving control applied to the vehicle 10 to level 2 autonomous driving control, the vehicle control unit 34 notifies the driver of a warning for requesting looking around the vehicle 10. When transferring control of the vehicle 10 to the driver of the vehicle 10, the vehicle control unit 34 notifies the driver of a warning that indicates transfer of control to the driver. The vehicle control unit 34 may further notify the driver of a warning for calling attention to a vehicle approaching from behind the vehicle 10, via the user interface 5.

In this way, the level of autonomous driving control applied to the vehicle 10 is changed to increase the driver's involvement in driving. This enables the vehicle control unit 34 to reduce the risk of a collision of the vehicle 10 with an emergency vehicle or a motorcycle approaching from behind the vehicle 10 even if it is difficult to detect the emergency vehicle or the motorcycle.

The vehicle control unit 34 may reduce the amount of adjustment to the position of the vehicle 10 in the host vehicle lane in a direction traversing the host vehicle lane, in the case where it is determined that traffic around the vehicle 10 is congested and where the rear detection range has been less than a second distance threshold for more than a second predetermined time. In the following, a direction traversing the host vehicle lane will be referred to as a lateral direction. For example, when the rear detection range has been less than a second distance threshold for more than a second predetermined time, the vehicle control unit 34 makes the amount of adjustment to the lateral position of the vehicle 10 less than when the rear detection range is not less than the second distance threshold. The second distance threshold is set to a value greater than the first distance threshold, e.g., between 40 m and 50 m. The second predetermined time is set, for example, from several seconds to a dozen or so seconds, and may be the same as or differ from the first predetermined time.

Reducing the amount of adjustment to the lateral position of the vehicle 10 in this way enables the vehicle control unit 34 to reduce the risk of a collision of the vehicle 10 with a motorcycle that is approaching from behind the vehicle 10 by weaving in and out of traffic.

The vehicle control unit 34 may determine whether to change the level of autonomous driving control applied to the vehicle 10 or whether to reduce the amount of adjustment to the lateral position of the vehicle 10, based on the rear detection range, regardless of whether traffic around the vehicle 10 is congested. For example, when the rear detection range has been less than the first distance threshold for more than the first predetermined time, the vehicle control unit 34 may change the level of autonomous driving control applied to the vehicle 10 to increase the degree of the driver's involvement in driving. For example, when level 2 autonomous driving control is applied to the vehicle 10, the vehicle control unit 34 requests the driver to hold the steering wheel. The vehicle control unit 34 notifies the driver of a warning for requesting the driver to hold the steering wheel, via the user interface 5. Alternatively, the vehicle control unit 34 may transfer control of the vehicle 10 to the driver of the vehicle 10. The vehicle control unit 34 may notify the driver of a warning that indicates transfer of control, via the user interface 5.

In this case also, the vehicle control unit 34 may reduce the amount of adjustment to the lateral position of the vehicle 10, when the rear detection range has been less than the second distance threshold for more than the second predetermined time.

It is supposed that a motorcycle approaching the vehicle 10 by weaving in and out of traffic behind the vehicle 10 is slower as the road being traveled by the vehicle 10 has a narrower lane. Thus the vehicle control unit 34 may set the first distance threshold smaller as the road being traveled by the vehicle 10 has a narrower lane. Similarly, the vehicle control unit 34 may set the second distance threshold smaller as the road being traveled by the vehicle 10 has a narrower lane. The vehicle control unit 34 refers to a high-precision map to identify a road including the current position of the vehicle 10 measured by the GPS receiver 2 as the road being traveled by the vehicle 10 and to identify the lane width of the identified road. In this way, the vehicle control unit 34 makes the level of autonomous driving control applied to the vehicle 10 less likely to be reduced as the road being traveled by the vehicle 10 has a narrower lane, which enables preventing a decrease in the driver's convenience.

When the road being traveled by the vehicle 10 has a road shoulder, an emergency vehicle approaching the vehicle 10 from behind the vehicle 10 probably travels on the road shoulder. An emergency vehicle traveling on a road shoulder is unlikely to be covered by a vehicle traveling behind on the host vehicle lane. Thus the vehicle control unit 34 may set the first distance threshold for the case where the road being traveled by the vehicle 10 has a road shoulder less than the first distance threshold for the case where the road being traveled by the vehicle 10 does not have a road shoulder. In this way, the vehicle control unit 34 makes the level of autonomous driving control applied to the vehicle 10 less likely to be reduced when the vehicle 10 is traveling on a road having a road shoulder, which enables preventing a decrease in the driver's convenience.

Further, when the road shoulder is empty, an emergency vehicle approaching the vehicle 10 from behind the vehicle 10 probably travels on the road shoulder. Thus, when the road being traveled by the vehicle 10 has a road shoulder, the vehicle control unit 34 determines whether the road shoulder of the road being traveled by the vehicle 10 is passable by another vehicle in the most recent predetermined period, based on the result of object detection by the detection unit 31. For example, when an object that may obstruct travel of an emergency vehicle is detected on the road shoulder in the most recent predetermined period, the vehicle control unit 34 determines that the road shoulder is impassable to another vehicle. When such an object is not detected on the road shoulder in the most recent predetermined period, the vehicle control unit 34 determines that the road shoulder is passable by another vehicle. The detection unit 31 can identify the lane being traveled by the vehicle 10, by comparing objects detected from an image with a high-precision map as will be described below, and identify an object on the road shoulder by processing similar to the above-described identification of a lane being traveled by a vehicle behind. An object that may obstruct travel of an emergency vehicle may be, for example, another vehicle or a three-dimensional object of a certain size, such as a fallen object. The detection unit 31 can determine whether a detected object is such an object, based on the type of the object outputted by the classifier. The vehicle control unit 34 may set the first distance threshold for the case where the road shoulder is passable by another vehicle in the most recent predetermined period less than the first distance threshold for the case where the road shoulder is impassable to another vehicle. In this way, the vehicle control unit 34 makes the level of autonomous driving control applied to the vehicle 10 less likely to be reduced when the road shoulder is passable by another vehicle, which enables preventing a decrease in the driver's convenience.

In addition, the vehicle control unit 34 controls the vehicle 10, depending on the level of autonomous driving control currently applied to the vehicle 10. For example, when autonomous driving control of level 2 or a higher level is applied to the vehicle 10, the vehicle control unit 34 sets a trajectory to be traveled by the vehicle 10 until a predetermined time ahead (hereafter a “planned trajectory”). The planned trajectory is represented, for example, as a set of target positions of the vehicle 10 at respective times during travel of the vehicle 10 through a predetermined section.

The vehicle control unit 34 sets a planned trajectory, by referring to a high-precision map, so that the vehicle 10 will travel along a planned travel route to a destination. The vehicle control unit 34 preferably sets a planned trajectory, by referring to predicted trajectories of traveling vehicles around the vehicle 10 until the predetermined time ahead, so as to keep at least a predetermined distance from the vehicles. The vehicle control unit 34 tracks the detected vehicles and applies a prediction filter, such as a Kalman filter, to the result of tracking to determine the predicted trajectories, as described in relation to the congestion determination unit 32.

In particular, when a large-size vehicle is traveling on a lane adjacent to the host vehicle lane, the vehicle control unit 34 may set a planned trajectory so as to increase the distance between the large-size vehicle and the vehicle 10. To this end, the vehicle control unit 34 adjusts the lateral position of the vehicle 10 in a direction from the center of the host vehicle lane to the side opposite the adjacent lane being traveled by the large-size vehicle, within the set amount of adjustment in the lateral direction.

Upon setting a planned trajectory, the vehicle control unit 34 controls components of the vehicle 10 so that the vehicle 10 travels along the planned trajectory. For example, the vehicle control unit 34 determines a target acceleration of the vehicle 10 according to the planned trajectory and the current speed of the vehicle 10 measured by a vehicle speed sensor (not illustrated), and sets the degree of accelerator opening or the amount of braking so that the acceleration of the vehicle 10 is equal to the target acceleration. The vehicle control unit 34 then determines the amount of fuel injection according to the set degree of accelerator opening, and outputs a control signal depending on the amount of fuel injection to a fuel injector of an engine of the vehicle 10. Alternatively, the vehicle control unit 34 controls a power supply of a motor for driving the vehicle 10 so that electric power depending on the set degree of accelerator opening is supplied to the motor. Alternatively, the vehicle control unit 34 outputs a control signal depending on the set amount of braking to the brake of the vehicle 10. In addition, the vehicle control unit 34 determines the steering angle of the vehicle 10 for the vehicle 10 to travel along the planned trajectory, based on the planned trajectory and the current position of the vehicle 10, and outputs a control signal depending on the steering angle to an actuator (not illustrated) that controls the steering wheel of the vehicle 10. The vehicle control unit 34 can estimate the position and direction of the vehicle 10 at the time of generation of the latest image by determining the position and direction of the vehicle 10 for the case where features detected from the image and projected onto a high-precision map match corresponding features on the high-precision map the best. The vehicle control unit 34 can estimate the current position of the vehicle 10 by correcting the position and direction of the vehicle 10 at the time of generation of the image, using, for example, the acceleration and yaw rate of the vehicle 10 from the time of generation of the image to the current time.

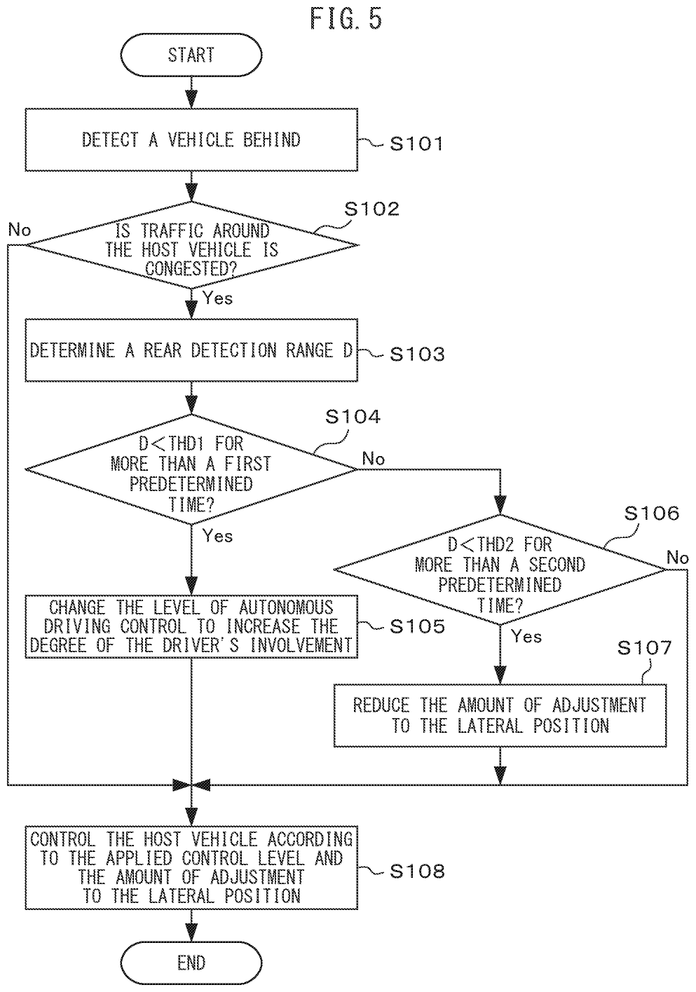

FIG. 5 is an operation flowchart of the vehicle control process executed by the processor 23. The processor 23 executes the vehicle control process at predetermined intervals in accordance with the operation flowchart described below.

The detection unit 31 of the processor 23 detects a vehicle traveling behind the vehicle 10 on the host vehicle lane (step S101).

The congestion determination unit 32 of the processor 23 determines whether traffic around the vehicle 10 is congested (step S102). When traffic around the vehicle 10 is congested (Yes in step S102), the detectable range determination unit 33 of the processor 23 determines a rear detection range d, based on the distance between the detected vehicle behind and the vehicle 10 (step S103).

The vehicle control unit 34 of the processor 23 determines whether the rear detection range d has been less than a first distance threshold Thd1 for more than a first predetermined time (step S104). When the rear detection range d has been less than the first distance threshold Thd1 for more than the first predetermined time (Yes in step S104), the vehicle control unit 34 changes the level of autonomous driving control applied to the vehicle 10. More specifically, the vehicle control unit 34 changes the level of autonomous driving control applied to the vehicle 10 to increase the degree of the driver's involvement in driving (step S105).

When the period during which the rear detection range d is less than the first distance threshold Thd1 is shorter than the first predetermined time (No in step S104), the vehicle control unit 34 maintains the level of autonomous driving control applied to the vehicle 10. The vehicle control unit 34 then determines whether the rear detection range d has been less than a second distance threshold Thd2 for more than a second predetermined time (step S106). As described above, the second distance threshold Thd2 is preferably set to a value greater than the first distance threshold Thd1.

When the rear detection range d has been less than the second distance threshold Thd2 for more than the second predetermined time (Yes in step S106), the vehicle control unit 34 reduces the amount of adjustment to the lateral position of the vehicle 10 (step S107).

After step S105 or S107, the vehicle control unit 34 controls the vehicle 10 according to the level of autonomous driving control applied to the vehicle 10 and the amount of adjustment to the lateral position (step S108). When traffic around the vehicle 10 is not congested in step S102 (No in step S102), the vehicle control unit 34 also executes control of the vehicle 10 in step S108. In addition, when the period during which the rear detection range d is less than the second distance threshold Thd2 is shorter than the second predetermined time (No in step S106), the vehicle control unit 34 also executes control of the vehicle 10 in step S108. The processor 23 then terminates the vehicle control process.

As described above, the vehicle control unit 34 may change the level of autonomous driving control applied to the vehicle 10 or the amount of adjustment to the lateral position of the vehicle 10, based on the rear detection range, regardless of whether traffic around the vehicle 10 is congested. In this case, processing of step S102 may be omitted. In addition, whether to refer to the result of determination whether traffic around the vehicle 10 is congested for changing the level of autonomous driving control applied to the vehicle 10 or the amount of adjustment to the lateral position may be switched depending on the level of autonomous driving control currently applied to the vehicle 10. For example, when level 3 autonomous driving control is applied to the vehicle 10, the vehicle control unit 34 refers to the result of determination whether traffic around the vehicle 10 is congested for changing the level of autonomous driving control applied to the vehicle 10 or the amount of adjustment to the lateral position. When level 2 autonomous driving control is applied to the vehicle 10, the vehicle control unit 34 does not refer to the result of determination whether traffic around the vehicle 10 is congested for changing the level of autonomous driving control applied to the vehicle 10 and the amount of adjustment to the lateral position. In this way, the vehicle control unit 34 can determine whether to change the level of autonomous driving control or the amount of adjustment to the lateral position more appropriately, depending on the level of autonomous driving control currently applied to the vehicle 10.

As has been described above, the vehicle controller determines a rear detection range within which an object is detectable behind a host vehicle, based on a sensor signal obtained by a sensor mounted on the host vehicle. The sensor is capable of detecting objects around the host vehicle. The vehicle controller changes the level of autonomous driving control applied to the vehicle to increase the degree of a driver's involvement in driving, when the rear detection range has been less than a first distance threshold for more than a first predetermined time. This enables the vehicle controller to reduce the possibility of a collision of the host vehicle with an object approaching from behind the host vehicle even if it is difficult to detect the approaching object.

According to a modified example, the detection unit 31 may detect vehicles behind, based on a sensor signal obtained by a sensor, other than the cameras 3-1 and 3-2, for sensing objects around the vehicle 10, e.g., a ranging signal of a range sensor. In this case, the classifier used by the detection unit 31 is trained in advance to detect a vehicle from a sensor signal obtained by the sensor for each of regions set within the detection range of the sensor. In this case also, the classifier may be configured by a DNN as in the embodiment or modified examples. Alternatively, the classifier may be one based on a machine learning technique different from a DNN, such as a support vector machine.

The computer program for achieving the functions of the processor 23 of the ECU 7 according to the embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present invention.

What is claimed is:

1. A vehicle controller that executes autonomous driving control of a vehicle, comprising a processor configured to:
determine a rear detection range within which an object is detectable behind the vehicle, based on a sensor signal from a sensor mounted on the vehicle, the sensor being capable of detecting objects around the vehicle, and
change the level of autonomous driving control applied to the vehicle to increase the degree of a driver's involvement in driving, when the rear detection range has been less than a first distance threshold for more than a first predetermined time.

2. The vehicle controller according to claim 1, wherein the processor is further configured to determine whether traffic around the vehicle is congested, and wherein
in the case where traffic around the vehicle is congested, the processor changes the level of autonomous driving control applied to the vehicle from a control level at which the driver's involvement is unnecessary to a control level at which the driver's involvement is necessary, when the rear detection range has been less than the first distance threshold for more than the first predetermined time.

3. The vehicle controller according to claim 1, wherein the processor is further configured to make, when the rear detection range has been less than a second distance threshold greater than the first distance threshold for more than a second predetermined time, the amount of adjustment to the position of the vehicle in a lane being traveled by the vehicle in a direction traversing the lane less than when the rear detection range is not less than the second distance threshold.

4. The vehicle controller according to claim 1, wherein the processor sets the first distance threshold for the case where a road being traveled by the vehicle has a road shoulder less than the first distance threshold for the case where the road being traveled by the vehicle does not have a road shoulder.

5. The vehicle controller according to claim 1, wherein the processor is further configured to detect an object in an area around the vehicle, based on the sensor signal, and wherein
the processor determines whether a road shoulder of a road being traveled by the vehicle is passable by another vehicle in a most recent predetermined period, based on the result of detection of the object, and sets the first distance threshold for the case where the road shoulder is passable by another vehicle less than the first distance threshold for the case where the road shoulder is impassable to another vehicle.

6. The vehicle controller according to claim 1, wherein the processor sets the first distance threshold smaller as a road being traveled by the vehicle has a narrower lane.

7. A vehicle control method for autonomous driving control of a vehicle, comprising:
determining a rear detection range within which an object is detectable behind the vehicle, based on a sensor signal from a sensor mounted on the vehicle, the sensor being capable of detecting objects around the vehicle; and
changing the level of autonomous driving control applied to the vehicle to increase the degree of a driver's involvement in driving, when the rear detection range has been less than a first distance threshold for more than a first predetermined time.

8. A non-transitory recording medium that stores a vehicle control computer program for vehicle control, the computer program causing a processor mounted on a vehicle to execute a process comprising:
determining a rear detection range within which an object is detectable behind the vehicle, based on a sensor signal from a sensor mounted on the vehicle, the sensor being capable of detecting objects around the vehicle; and
changing the level of autonomous driving control applied to the vehicle to increase the degree of a driver's involvement in driving, when the rear detection range has been less than a first distance threshold for more than a first predetermined time.
